(19) United States
(12) Patent Application Publication
(10) Pub. No.: US 2018/0075407 A1
(43) Pub. Date: Mar. 15, 2018

(54) PEER TO PEER DELIVERY OF GOODS WITHIN ONES GENERAL NEIGHBORHOOD OR EN ROUTE FROM A PLACE OF PURCHASE OR SITE OF DISTRIBUTION TO THEIR RESIDENCE OR PLACE OF WORK FOR A FEE

(71) Applicant: RAMANA V. CHIVUKULA, MORRISVILLE, PA (US)

(72) Inventor: RAMANA V. CHIVUKULA, MORRISVILLE, PA (US)

(21) Appl. No.: 15/261,943

(22) Filed: Sep. 10, 2016

(51) Int. Cl. G06Q 10/08; H04L 29/08

(52) U.S. Cl. CPC G06Q 10/0834; H04L 67/26; H04L 67/104

(57) ABSTRACT

The present invention relates to the Peer to peer network for delivery of goods by the customers of the business/establishment to other customers who are in their residential or work neighborhood. A database is maintained for the authorized P2P Delivery Persons. Whenever they plan or come to the establishment/point of purchase, a list of pending deliveries can be offered to them at checkout/through alerts and they may select the deliveries to be delivered. Once the product is delivered, a confirmation mail is sent back to the server and the P2P Delivery Person is paid a pre-determined fee.

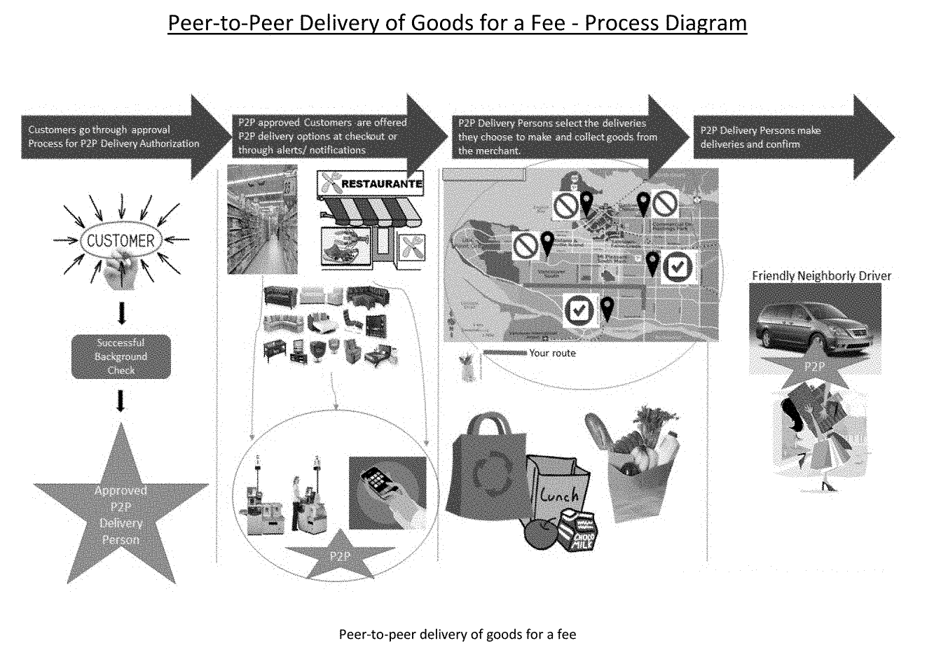

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### Definitions

Peer-to-peer (P2P): Customers shopping from the same stores (non-professional delivery drivers or delivery/logistics contractors) in the same general neighborhood.
Neighborhood: Within 5-20 Mile radius of the place of purchase or place of residence/work of the deliverer.
En-route: Within 5-10 Mile deviation from one's original route—from place of purchase to one's place of residence or work.
Fee: Any compensation either paid in cash, credit or kind.
Place of purchase: A store, warehouse, point of sale, point of distribution, or point of redistribution.
Background check: An existing customer that would like to deliver goods to other customers as a ‘Peer-to-peer delivery person’ needs to undergo background checks for criminal, drug abuse, license and residence verification, SSN verification, sex offense, etc to be authorized.
Delivery of goods: Physical movement of goods from a store or warehouse to a client's residence or work
Authorization: Businesses that would like to utilize peer-to-peer delivery services, directly or through an agent verifying the background of the customer(s) that would like to deliver goods to other customers as authorized peer-to-peer delivery persons.

### BACKGROUND

The present invention is a method or process embodying use of a software for P2P delivery of perishable and non-perishable goods within the general neighborhood of one's residence or work, or within 5-10 Mile deviation from the general route of the place of purchase (or distribution point) to one's place of residence or work for a fee. This invention further embodies background checks of persons who are customers and at the same time want to become a part of the P2P network to deliver goods to other customers. It also prompts the place of purchase and the customers when the order is delivered in good condition.

The science and technology has advanced in leaps and bounds and the quality of life has increased significantly. The needs of consumerism and commerce have also been met in a variety of improvements including online delivery of products thus saving of time and labor. There are numerous patents which have demanded peer-to-peer network deliveries however the deliveries have been purely through technology and software. The present invention details a simple process which is beneficial for small as well as big distribution/shopping outlets by utilizing customer manpower in their customer network. Some of the prior arts in this field are detailed in this application.

The traditionally known P2P network of file sharing by arranging and ranking users is disclosed in the U.S. Pat. No. 8,185,433B2. It discloses a system manager based and implementable, sourcing-provider selected and entrepreneurially vetted peer, P2P electronic-commerce method (a) implementable in, and employing the structure of, an electronic-information communication and exchange network, and (b) involving system-manager-promoted, sourcing-provider vetted, authorized, and incentivized selected-peer entrepreneurship, said method, as implemented by a system manager, comprising choosing an active P2P network group which is characterized with peers having an affinity interest in defined, income-transactible, affinity-interest-associated subject matter, creating, in network-connected computer structure, a network-accessible, but limited-access, digital-data catalogue of purchasable deliverables, including sourcing-provider furnished, income-transactible, affinity-interest-associated and ancillary subject matter represented by electronic data stored in the catalogue, limiting access to subject matter represented by data stored in the created catalogue to only (a) an entrepreneurially-talented vetted peer, and (b) another party who is a potential purchaser, and to whom such access is furnished specifically, and only, by such a vetted peer, and solely for the purpose of considering, and if desired engaging in, the purchase of a catalogue-displayed deliverable. There are prior arts who encourage delivery of goods in neighbourhood by a copter as is claimed in U.S. Pat. No. 9,070,101 B2 which is a method, device and system of an autonomous neighborhood multi-copter commerce network in a community. In one embodiment, an autonomous neighborhood multi-copter includes a storage compartment of the autonomous neighborhood multi-copter in which items are storable, a computer system of the autonomous neighborhood multi-copter that is communicatively coupled to a commerce server of a neighborhood communication system through a wireless network to autonomously navigate the autonomous neighborhood multi-copter to a destination in the neighborhood specified by the commerce server using a peer-to-peer network of client side devices in the neighborhood that are geo-constrained to a location of a defined neighborhood, and a navigation server of the autonomous neighborhood multi-copter to provide a remote sensing capability to the autonomous neighborhood multi-copter such that the autonomous neighborhood multi-copter is autonomously navigable to the destination using the peer-to-peer network. The U.S. Pat. No. 8,326,827 B2 discloses methods and systems for providing a list of peers that satisfy a query. A plurality of peer profiles are obtained from a data repository, each having a degree of association with the query originating peer. A first and second group of peers, respectively having a first and second degree of association with the query originating peer are determined. A third group of peers that satisfy the query are determined. A fourth group of peers is determined from the third group based on an assigned score to each of the peers in the first and second group, the assigned score reflecting a degree of association between the query originating peer and each of the peers in the first and second group. Results are ranked based on the assigned score. The present invention is a drastic variant compared to the methods and processes disclosed in the prior art. The present invention involves humans in the delivery of goods or products within a certain radius or distance.

The invention US 20030018701 A1 provides peer to peer collaboration communications network architecture is disclosed wherein a plurality of enterprises effectively communicate with one another to share data across a single network. The network architecture simplifies management by partitioning supply chain network enterprises into groups that are independently managed. The network architecture allows for high speed transactions by minimizing distributions of queries upon multiple enterprise networks. At the same time, the network architecture allows for security and privacy concerns of individual enterprises to be addressed within small, localized portions of the overall network architecture. Users of the architecture therefore have the flexibility of choosing between overall speed and localized security modeling. The network architecture comprises a plurality of sub networks that are communicative with one another. Security and privacy concerns are modeled into the sub networks, while the overall architecture takes its shape and robust scalability from the interconnections of the plurality of sub networks. Another Patent US 20060089886 A1 provides E-commerce business methodologies by providing system and method for providing integrated logistics services. In the system, an electronic trading facility, a logistics services group, a commercial-finance group; and an information-support group are organized and arranged to communicate and exchange information with each other over the Internet in order to provide logistics services to a customer. However, the present invention is not found with the same functionality and features in the prior art.

The present invention is an improvement as it presents a peer-to-peer network for delivery of goods which can reduce cost of delivery trucks and driver wages, business can leverage a trip that a customer is making to the store for his own purchase of goods to deliver goods to other customers that might have ordered online thereby reducing the miles driven and cost of delivery. Deliveries have traditionally been done by professional logistics/transportation companies, company's own drivers, etc. Peer-to-peer (P2P) delivery process enables neighbors or people from a neighbourhood deliver goods for each other from shops where they usually buy goods from such as grocery shops, restaurants, malls, furniture shops, etc. Without being a professional delivery person or full time employee of a company, a person can choose to make some money by delivering goods while s/he is anyways making a trip to a particular shop or shops at a mall or a restaurant etc. It also provides a background check and gives the orders to preferred customers thereby ensuring safety, quality of goods and timely delivery. It also keeps the customer motivated to deliver goods for money consideration. Therefore, the present invention is personally and commercially an advantage over what already existed in prior art.

The limitations and non-effectiveness of the prior art has been overcome by the instant invention as described below.

### BRIEF SUMMARY OF THE INVENTION

The foregoing descriptions outline some pertinent features and objects of the present invention. These may be illustrative of more exhaustive and comprehensive features described later in the application. The technical terms used in this documents, are meant with the same meaning as understood by a typical expert of the field which is related to the invention

The present invention is a method or process embodying use of a software for P2P delivery of perishable and non-perishable goods within the general neighborhood of one's residence or work, or within 5-10 Mile deviation from the general route of the place of purchase (or distribution point) to one's place of residence or work for a fee.

In the present embodiment, Customers of a business that want to double up as P2P Delivery Persons go through background check/s. Upon successful clearance through background checks, they are authorized as P2P Delivery Persons and an authorized server can be maintained by the business establishments with P2P Delivery Person Database. In another aspect of the invention, a P2P Delivery Person that is at a store with his/her credentials validated, can be offered a list of pending deliveries in his/her neighborhood or en route to his/her neighborhood by a store clerk or a kiosk and allow them to select the deliveries that they would like to make based on the P2P delivery rules set by a business. Upon confirmation of ‘delivery in good condition’ by P2P Delivery Person and the customer, a fee is paid to the P2P Delivery Person.

The objective of the present invention is to provide the best methods and systems for delivery of perishable and non-perishable goods at lower costs. Goods are delivered within a short deviation from one's original route—5-10 miles, within general neighbourhood of one's residence or place of work and within 5-10-mile deviation of one's normal route to get from the place of purchase to place of residence or work. Businesses can leverage their customer network and their knowledge of the neighborhood to deliver goods thereby reducing cost of delivery to business. Business can reduce cost of Delivery trucks and Driver wages etc, contribute to reduction of carbon emissions by reducing the miles driven to deliver their goods to their customers and families can spend more time together and spend quality time by reducing time spent commuting for mundane tasks such as grocery shopping, restaurant pickup, online order pickup etc.

These and other features, objects and advantages of the present invention will be readily visible to the persons ordinarily skilled in the art related to this field comprehending in entirety the above characteristics, following descriptions and claims of the present invention

### BRIEF DESCRIPTION OF THE DRAWINGS

The Flowchart is a diagrammatic representation of the ‘Peer-to-Peer Delivery of Goods for a Fee’.

### DETAILED DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized.

The Flowchart depicts the business model of the present invention. Customers of a business, who want to double up as P2P Delivery, go through background check/s and upon successful clearance through background checks, they are authorized as ‘P2P Delivery Persons’ 101. These deliveries are effective because during background check, the customer who is selected for making the delivery is the one with clean driving and criminal record and who lives in that particular area and has a good knowledge of that area. Deviation from his planned route for his own trip can be less than 20 miles in total. For carrying out the operations, an authorized set of ‘P2P Delivery Person Database’ 106 could be maintained centrally by an Independent Service Provider or a business or can also be maintained locally by individual businesses. Authorized P2P Delivery Persons can opt for push or pull notifications on pending deliveries in their neighbourhood or along their route to place of work or place business through an app or automated voice or text alerts. In addition, a P2P Delivery Person that is at a store with his credentials validated, can be offered a list of pending deliveries in his/her neighborhood or en route to his place of residence or place of work by a store clerk or a kiosk and allow them to select the deliveries that they would like to make based on the P2P delivery rules set by a business 102, 103. The P2P customers may select the deliveries and confirm if they want to deliver those goods within the said locality 103. The delivery is then made by the P2P customer 104. Upon confirmation of ‘delivery in good condition’ by P2P Delivery Person and the customer, a pre-determined fee is paid to P2P Delivery Person for delivering the goods based on the distance, weight of the goods, and other considerations 105.

Some scenarios for the utility of the present patent can be described here. [A] A grocery chain could utilize their customer network to deliver online orders at a lower cost compared to a dedicated fleet of trucks or contracted delivery services. They can encourage their customers to register to be ‘peer-to-peer’ delivery persons. Upon conducting background checks, grocery chain would confirm registration of such customers as P2P Customers. When an authorized P2P Delivery Person logs into the P2P app or business website or presents himself to a kiosk at the store, s/he will be notified of pending deliveries in their neighborhood or en-route. They can select and confirm the deliveries they would like to make and the store will then hand them the merchandize to be delivered along with the necessary route and additional instructions applicable for those deliveries. Upon confirmation that the delivery is made, a predetermined fee is paid. Grocery store could reduce the cost of their online order deliveries by up to 50% through P2P Customer Delivery network. ‘Delivery in good condition’ confirmation is obtained from the P2P delivery person as well as the end customer before a fee is paid. [B] A restaurant can grow their business by delivering more orders through P2P Customer Delivery. Regular customers or Eat-in customers that are authorized P2P Delivery Persons, can pick up online orders that can be delivered in their neighborhood or on their way home. Deliveries are selected on their mobile device or at a kiosk or the restaurant could provide the list for the customer to choose from. Upon confirmation of delivery, a fee is paid to the P2P Delivery Person. ‘Delivery in good condition’ confirmation is obtained from the P2P delivery person as well as the end customer before a fee is paid. [C] A packet that needs to be delivered by a business/individual to another individual/business in the general neighbourhood of one's place of residence or work can be picked up by an authorized person (someone that has gone through the background check process successfully) for delivery. Individuals and Businesses can save from 10-50% on the cost of delivery through a regular courier service (like UPS, Fedex, or USPS). ‘Delivery in good condition’ confirmation is obtained from the P2P delivery person as well as the end customer before a fee is paid.

Although the invention has been explained in relation to its preferred embodiment, it is to be understood that many other possible modifications and variations can be made without departing from the spirit of the scope of the invention.

What is claimed for is:

1. A system and method which has the capability of providing assistance managing P2P deliveries.

2. The method in claim 1 comprising of:
a person or customer goes through approval process for P2P delivery, where approval is on the basis of his/her successful clearing of background check and his place of residence
an authorized set of ‘P2P Delivery Person Database’ which is maintained centrally by an Independent Service Provider or locally by Individual businesses;
an authorized P2P Delivery Person where s/he may opt for push or pull notifications on pending deliveries in their neighborhood through an app or automated voice or text alerts;
a P2P Delivery Person who is at the store with approved P2P credentials validated may choose to take up deliveries on the basis of predetermined rules that determine the neighbourhood and route of travel and others;
a system where upon successful delivery of goods the system is updated and a predetermined fee is paid to the P2P delivery person.

3. The method in claim 2 may preferably be used by grocery stores and other stores who require delivering products.

4. The method in claim 2 having the capability of operation cost of delivering products in an effective manner.
